(19) United States
(12) Patent Application Publication
(10) Pub. No.: US 2024/0142172 A1
(43) Pub. Date: May 2, 2024

(54) A Freeze Dryer and a Method for Operating a Freeze Dryer

(71) Applicant: GEA Lyophil GmbH, Hürth (DE)

(72) Inventors: Thomas Heinrich Ludwig Beutler, Bergheim (DE); Maximilian Toennessen, Erftstadt (DE); Frank Krüger, Pulheim (DE); Olaf Plassmann, Odenthal (DE)

(21) Appl. No.: 18/279,629

(22) PCT Filed: Mar. 2, 2022
(86) PCT No.: PCT/EP2022/055260

§ 371 Date: Sep. 1, 2023

(30) Foreign Application Priority Data
Mar. 5, 2021 (EP) 21160974.8

(51) Int. Cl. F26B 5/06; F25B 9/00; F25B 41/20

(52) U.S. Cl. CPC F26B 5/06; F25B 9/008; F25B 41/20

(57) ABSTRACT

A freeze dryer that includes a product chamber configured to accommodate products to be freeze-dried; a condenser connected to the product chamber and configured to trap water during a freeze-drying process; a product chamber cooling circuit configured to cool the product chamber, the product chamber cooling circuit having a first heat transfer fluid; a condenser cooling circuit configured to cool the condenser, the condenser cooling circuit having a second heat transfer fluid and being separate from the product chamber cooling circuit; a first additional cooling circuit having carbon dioxide or ammonia or liquid nitrogen as refrigerant; and a first heat exchanger configured to transfer heat between the condenser cooling circuit and the first additional cooling circuit.

### CROSS REFERENCE TO RELATED APPLICATIONS

This application is a US National Stage entry of PCT/EP2022/055260 filed on Mar. 2, 2022, which claims priority to EP 21160974.8 filed Mar. 5, 2021.

### FIELD

The present invention relates to the field of freeze drying also known as lyophilization. It finds application in the life sciences industry, in particular in the pharmaceutical industry.

### BACKGROUND

Freeze drying is a dehydration process typically used to preserve a perishable material or make the material more convenient for transport or storage. Freeze drying works by freezing material and then reducing the surrounding pressure to allow the frozen water in the material to sublimate directly from the solid phase to the gas phase.

The products to be freeze-dried are typically placed inside a product chamber, e.g. in a shelf arranged inside the product chamber. A condenser is connected to the product chamber via a gas passage that is closed when freezing the products in the products chamber, e.g. down to a temperature in the range of −20° C. to −55° C. Simultaneously, the condenser is cooled to a temperature below the temperature of the products, e.g. down to −75° C. Then, the product chamber is evacuated to a low-pressure condition to reach the triple point of the products. The gas passage is opened and sublimated vapors are withdrawn from the product chamber into the condenser. The condenser typically includes coils or plates that trap water.

Currently available freeze dryers for life sciences applications usually include fluorinated gases as refrigerants. However, as those refrigerants are becoming less common and increasingly more restrictive laws prohibit use of chemicals with high global warming potential (GWP), it is desired to employ low GWP refrigerants in freeze drying applications.

A well-known cooling technology using a low GWP refrigerant is air cycle cooling. The underlying process is known as the reverse Brayton or Bell Coleman cycle and is based on the compression and expansion of a constant air volume. Thus, unlike conventional cooling systems it is not based on evaporation or phase exchange. Repeating the compression and expansion cycles allows to reach and maintain ultra-low temperatures down to −160° C. However, compared to refrigerating capacity efficiencies with a conventional compressor, air cycle cooling shows a reduced coefficient of performance (COP) at higher temperatures, e.g. temperatures above −50° C. The coefficient of performance is the ratio of useful cooling provided to work required.

### SUMMARY

In light of these considerations, it would be advantageous to provide a freeze dryer employing low GWP refrigerants that has an increased coefficient of performance and a respective method of operating the freeze dryer.

To better address this concern, in a first aspect of the invention, a freeze dryer is presented, comprising
a product chamber configured to accommodate products to be freeze-dried,
a condenser connected to the product chamber and configured to trap water during a freeze-drying process,
a product chamber cooling circuit configured to cool the product chamber, the product chamber cooling circuit comprising a first heat transfer fluid,
a condenser cooling circuit configured to cool the condenser, the condenser cooling circuit comprising a second heat transfer fluid and being separate from the product chamber cooling circuit,
characterized by
a first additional cooling circuit comprising carbon dioxide or ammonia or liquid nitrogen as refrigerant, and
a first heat exchanger configured to transfer heat between the condenser cooling circuit and the first additional cooling circuit.

The freeze dryer according to the invention is in particular a batch freeze dryer for application in the pharmaceutical industry. The product chamber cooling circuit is configured to cool the product chamber and makes use of a first heat transfer fluid. The condenser is cooled by a separate condenser cooling circuit that also includes a second heat transfer fluid. Due to the first heat exchanger and the first additional cooling circuit comprising carbon dioxide (CO₂) or ammonia (NH₃) or liquid nitrogen (LN2 or liquid N₂) as refrigerant, additional cooling capacity can be provided to the condenser cooling circuit, in particular at temperatures above −50° C.

Thus, the inventive freeze dryer allows to employ a technology for cooling the condenser which is less effective at temperatures above −50° C. but has high effective at temperatures below −50° C. With the inventive freeze dryer, it is possible to withdraw heat from the condenser cooling circuit at temperatures above −50° via the first heat exchanger and the first additional cooling circuit and to withdraw heat at temperatures below −50° by other means. Because carbon dioxide (GWP=1) and ammonia (GWP=0) and liquid nitrogen (GWP=0) have low GWP, a freeze dryer employing low GWP refrigerants can be attained which has an increased coefficient of performance.

The first and second heat transfer fluids may be of the same type or may be of different type. Preferably, the first heat transfer fluid and/or the second heat transfer fluid is a silicone oil. Alternatively, the first heat transfer fluid and/or the second heat transfer fluid may be selected from the group of mineral oils, in particular low temperature mineral oils, ethylene glycol or brine.

The increased efficiency of the freeze dryer at higher temperatures can in particular be exploited when cooling the condenser after sterilization. During sterilization, in particular during sterilization in place (SIP), the condenser and the condenser cooling circuit are typically heated up to a given sterilization temperature, e.g. above 121,1° C. By use of the first heat exchanger and the additional cooling circuit, cooling of the condenser may be carried out with increased speed and efficiency.

According to the invention, the product chamber may include a shelf configured to accommodate the products. If the product chamber includes a shelf, the product chamber cooling circuit is preferably configured to cool the product chamber via one or more ducts arranged at the shelf or integrated into the shelf of the cooling chamber.

According to a preferred embodiment of the invention, the first additional cooling circuit comprises a valve, in particular a proportional valve, for adjusting refrigerant flow through the first heat exchanger. Preferably, the valve can be selectively set to a fully closed position in which refrigerant flows through the valve and the first heat exchanger is stopped and an open position in which refrigerant can flow through the valve and the first heat exchanger. The valve can be set to the fully closed position in order to thermally decouple the first additional cooling circuit from the condenser cooling circuit. If the valve is in the open position, the first additional circuit is thermally coupled to the condenser cooling circuit.

According to a preferred embodiment of the invention, the freeze dryer includes an air cycle cooling system configured to cool the second heat transfer fluid of the condenser cooling circuit. The air cycle cooling system uses air as a refrigerant which is environmentally neutral. The GWP of air is 0. Air cycle cooling systems are reliable and durable, thereby reducing maintenance costs and ensuring a long lifecycle without loss of performance. Air cycle cooling systems typically have a high coefficient of performance for low temperatures e.g., temperatures below −50° C., which are required to be reached in the condenser of the freeze dryer. The air cycle cooling system may cool the second heat transfer fluid of the condenser cooling circuit and the condenser alone without the first additional cooling circuit being actively withdrawing heat from the condenser cooling circuit. Alternatively, the air cycle cooling system may cool the second heat transfer fluid of the condenser cooling circuit and the condenser together with the first additional cooling circuit. Preferably, the freeze dryer is configured to cool the second heat transfer fluid of the condenser cooling circuit and the condenser alone without the first additional cooling circuit being actively withdrawing heat from the condenser cooling circuit if a temperature of the condenser and/or of the second heat transfer fluid of the condenser cooling circuit is below a first predetermined threshold temperature, the first predetermined threshold temperature being in the range from −40° C. to −50° C., for example −45° C. The air cycle cooling system may cool the second heat transfer fluid of the condenser cooling circuit and the condenser together with the first additional cooling circuit if the temperature of the condenser and/or of the second heat transfer fluid of the condenser cooling circuit is greater than the first predefined threshold temperature. Preferably, the freeze dryer is additionally configured to deactivate the air cycle cooling system, if the temperature of the condenser and/or of the second heat transfer fluid of the condenser cooling circuit is greater than a second predefined threshold temperature, the second predefined threshold temperature being equal or higher than the first predefined threshold temperature, e.g. the second predefined threshold temperature being in the range from −20° C. to −40° C., for example −20° C.

According to a preferred embodiment of the invention, the freeze dryer comprises a second heat exchanger configured to couple the air cycle cooling system and the condenser cooling circuit. The second heat exchanger is preferably an air-oil heat exchanger.

According to a preferred embodiment of the invention, the freeze dryer comprises a third heat exchanger configured to transfer heat between the product chamber cooling circuit and the condenser cooling circuit. The third heat exchanger provides the advantage that heat can be withdrawn from the product chamber cooling circuit to the condenser circuit. A cooling system provided in the condenser cooling circuit, in particular an air cycle cooling system, can thus be employed for cooling the product chamber as well.

According to a preferred embodiment of the invention, the freeze dryer includes a valve, in particular a three-way valve, configured to selectively couple the third heat exchanger to the condenser cooling circuit or decouple the third heat exchanger from the condenser cooling circuit. The valve may comprise three ports, wherein a first port is connected to an inlet of the third heat exchanger, a second port is connected to an outlet of the third heat exchanger and a third port is not connected to any of the inlet or outlet of the third heat exchanger but only to the condenser cooling circuit. In other words, the three-way valve connects the condenser cooling circuit to a heat exchanger path, wherein second heat transfer fluid flowing through the heat exchanger path passes the third heat exchanger, and a bypass path, wherein refrigerant flowing through the bypass pass does not pass the third heat exchanger. Preferably, the three-way valve is provided as a proportional three-way valve so that flow through the third heat exchanger and bypass flow may be set in a way that a first amount of second heat transfer fluid flows through the third heat exchanger and an second amount of second heat transfer fluid bypasses the third heat exchanger. Thereby, heat transfer between the product chamber cooling circuit and the condenser cooling circuit may be adjusted.

According to a preferred embodiment of the invention, the freeze dryer comprises a fourth heat exchanger configured to transfer heat between the product chamber cooling circuit and the first additional cooling circuit or a second additional cooling circuit comprising carbon dioxide or ammonia or liquid nitrogen as refrigerant. Via the fourth heat exchanger heat may be withdrawn from the product chamber cooling circuit to the first additional cooling circuit or a second additional cooling circuit comprising carbon dioxide or ammonia or liquid nitrogen as refrigerant. Preferably, the first or second additional cooling circuit comprises a valve, in particular a proportional valve, for adjusting refrigerant flow through the fourth heat exchanger. Preferably, the valve can be selectively set to a fully closed position in which refrigerant flow through the valve and the fourth heat exchanger is stopped and an open position in which refrigerant can flow through the valve and the fourth heat exchanger. The valve can be set to the fully closed position in order to thermally decouple the first or second additional cooling circuit from the product chamber cooling circuit. If the valve is in the open position, the first additional circuit is thermally coupled to the product chamber cooling circuit.

According to a preferred embodiment of the invention, the freeze dryer includes one or more heaters configured to selectively heat the first heat transfer fluid of the product chamber cooling circuit. The one or more heaters are preferably connected to the product chamber cooling circuit. The one or more heaters may be used for heating the products in the cooling chamber during freeze drying in order to start sublimation of water from the products.

According to another aspect of the invention, a method of operating a freeze dryer is presented, comprising
a product chamber configured to accommodate products to be freeze-dried,
a condenser connected to the product chamber and configured to trap water during a freeze-drying process,
a product chamber cooling circuit configured to cool the product chamber, the product chamber cooling circuit comprising a first heat transfer fluid,
a condenser cooling circuit configured to cool the condenser, the condenser cooling circuit comprising a second heat transfer fluid and being separate from the product chamber cooling circuit,
the method comprising the following method step:
in a condenser cooling step, heat is transferred from the condenser cooling circuit to a first additional cooling circuit comprising carbon dioxide or ammonia or liquid nitrogen as refrigerant via a first heat exchanger.

With the method according to the invention, the same benefits may be attained as already described in conjunction with the freeze dryer according to the invention. In particular, the additional cooling circuit provides additional cooling capacity to the condenser, in particular at temperatures above −50° C. Thus, the method of operating the freeze dryer allows to employ a technology for cooling the condenser which is less effective at temperatures above −50° C. but has high effective at temperatures below −50° C. In a first part of the condenser cooling step, heat may be withdrawn from the condenser cooling circuit at temperatures above −50° via the first heat exchanger and the additional cooling circuit comprising carbon dioxide. Thereby it is possible to withdraw heat at temperatures below −50° by other means. Because carbon dioxide (GWP=1) and ammonia (GWP=0) and liquid nitrogen (GWP=0) have low GWP, a method of operating a freeze dryer employing low GWP refrigerants can be attained which has an increased coefficient of performance.

According to a preferred embodiment of the invention, in the condenser cooling step, the condenser cooling circuit is additionally cooled by an air cycle cooling system. As previously discussed, the air cycle cooling system uses air as a refrigerant which is environmentally neutral. The GWP of air is 0. Air cycle cooling systems are reliable and durable, thereby reducing maintenance costs and ensuring a long lifecycle without loss of performance. Air cycle cooling systems typically show high cooling capacity efficiency for low temperatures e.g., temperatures below −50° C., which are required to be reached in the condenser of the freeze dryer. The air cycle cooling system may cool the second heat transfer fluid of the condenser cooling circuit and the condenser together with the first additional cooling circuit if the temperature of the condenser and/or of the second heat transfer fluid of the condenser cooling circuit is greater than a first predetermined threshold temperature, the first predetermined threshold temperature being in the range of −40° C. to −50° C., for example −45° C.

According to a preferred embodiment of the invention, the method further includes the following method step:
in a product cooling step, performed simultaneously with or following the condenser cooling step, heat is transferred from the product chamber cooling circuit to the condenser cooling circuit via a third heat exchanger.

The third heat exchanger provides the advantage that heat can be withdrawn from the product chamber cooling circuit to the condenser circuit. The first additional cooling circuit coupled to the condenser cooling circuit can thus be employed for cooling the product chamber as well. Due to the low temperature of liquid nitrogen, this option is in particular appealing if the additional cooling circuit comprises liquid nitrogen as refrigerant. If the condenser cooling circuit is additionally cooled by the air cycle cooling system, the air cycle cooling system also contributes to cooling the product chamber.

According to a preferred embodiment of the invention, a temperature of the product chamber is set by adjusting a proportional valve of the condenser cooling circuit, in particular a proportional three-way valve. The valve may comprise three ports, wherein a first port is connected to an inlet of the third heat exchanger, a second port is connected to an outlet of the third heat exchanger and a third port is not connected to any of the inlet or outlet of the third heat exchanger but only to the condenser cooling circuit. In other words, the three-way valve connects the condenser cooling circuit to a heat exchanger path, wherein second heat transfer fluid flowing through the heat exchanger path passes the third heat exchanger, and a bypass path, wherein second heat transfer fluid flowing through the bypass pass does not pass the third heat exchanger. Consequently, flow through the third heat exchanger and bypass flow may be set in a way that a first amount of second heat transfer fluid flows through the third heat exchanger and a second amount of second heat transfer fluid bypasses the third heat exchanger.

According to a preferred embodiment of the invention, in the product cooling step, heat is transferred from the product chamber cooling circuit to the first additional cooling circuit via a fourth heat exchanger or to a second additional cooling circuit comprising carbon dioxide or ammonia or liquid nitrogen as refrigerant via a fourth heat exchanger. Preferably, refrigerant flow through the fourth heat exchanger is adjusted by a valve, in particular a proportional valve, of the first or second additional cooling circuit, respectively. Preferably, in the product cooling step, the valve is set to an open position in which refrigerant can flow through the valve and the fourth heat exchanger, if the temperature of the product chamber or the temperature of the first heat transfer fluid of the product chamber cooling circuit is within a predetermined range, in particular the range from −40° C. to −51° C.

According to a preferred embodiment of the invention, the method further includes the following method step:
in a freeze-drying step, performed following the condenser cooling and product cooling steps, the third heat exchanger is decoupled from a flow of second heat transfer fluid in the condenser cooling circuit so as to reduce heat transfer from the product chamber cooling circuit to the condenser cooling circuit, wherein the first heat transfer fluid of the product chamber cooling circuit is heated by one or more heaters. Thereby, an appropriate temperature for sublimation of water can be provided in the product chamber whereas the condenser can be cooled to a low temperature in order to attain good condensation properties of the condenser.

According to a preferred embodiment of the invention, in the freeze-drying step, the first heat exchanger is decoupled from a flow of refrigerant in the first additional cooling circuit so as to reduce heat transfer from the condenser cooling circuit to the first additional cooling circuit. For decoupling the first heat exchanger from the flow of refrigerant in the first additional cooling circuit, a valve in the first additional cooling circuit may be closed, thereby delimiting refrigerant flow through the valve and the first heat exchanger. By reducing heat transfer from the condenser cooling circuit to the first additional cooling circuit, cooling of the refrigerant of the condenser cooling circuit is essentially effected by the air cycle cooling system of the condenser cooling circuit. Because the air cycle cooling system is more efficient at low temperatures as compared to the first additional cooling circuit, efficiency of the freeze dryer at low temperature operation, in particular at a condenser temperature below −50° C. may be increased.

In regards to the freeze dryer and the corresponding method of operation, the product chamber may include a shelf, wherein the shelf is cooled by the product chamber cooling circuit. For example, a conduit of the product chamber cooling circuit may run through a part and/or an element of the shelf. Additionally, or alternatively, a conduit of the product chamber cooling circuit may be arranged inside the product chamber and/or inside a wall of the product chamber.

### BRIEF DESCRIPTION OF THE DRAWINGS

These and other aspects of the invention will be apparent from and elucidated with reference to the embodiments described hereinafter.

FIG. 1 is a schematic representation of a freeze dryer in accordance with an embodiment of the invention.

FIG. 2 is a schematic representation of an embodiment of the method of operating a freeze dryer in accordance with an embodiment of the invention.

### DETAILED DESCRIPTION

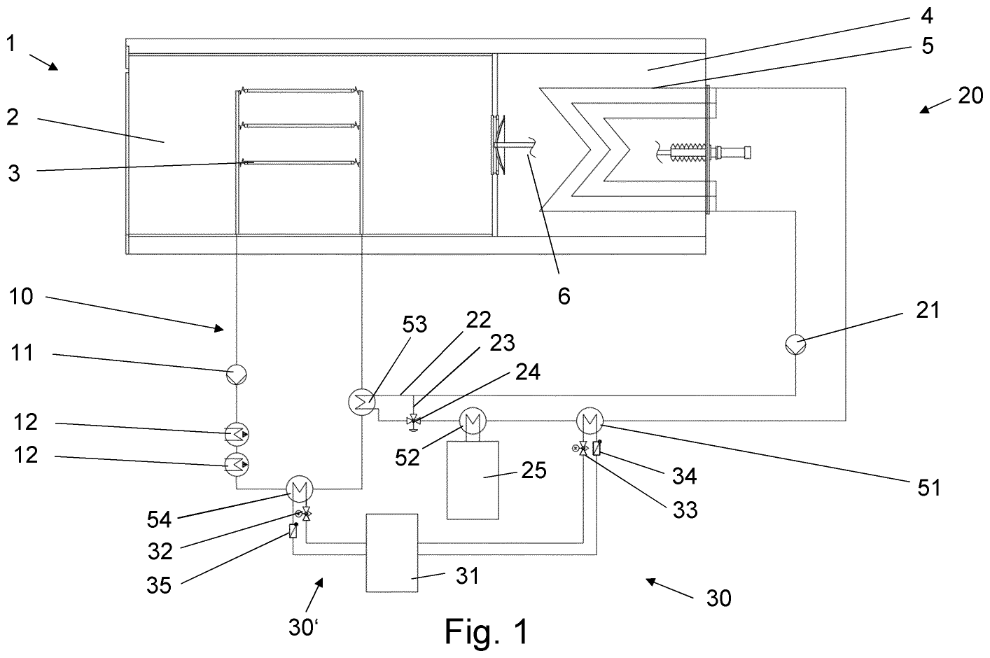

FIG. 1 illustrates a schematic diagram of a freeze dryer 1 in accordance with an embodiment of the invention. The freeze dryer 1 is configured as a batch freeze dryer for pharmaceutical applications and comprises a product chamber 2 configured to accommodate products to be freeze-dried. Those products may be provided in vials that can be arranged on a shelf 3 that is arranged in the product chamber 2. The freeze dryer 1 further includes a condenser 4 connected to the product chamber 2. The condenser 4 includes multiple condenser coils 5 or condenser plates arranged inside a condenser chamber. The condenser 4, in particular the condenser chamber of the condenser 4, is connected to the product chamber 2 via a gas passage 6. The gas passage can selectively be closed by a gas passage closure or kept open. The closure is configured to be moved between its closed position and its opened position during operation of the freeze dryer 1. For example, the gas passage closure will be kept in its closed position when the products and the condenser 4 are cooled down prior to the drying step. During the freeze-drying step, the gas passage closure is kept in its opened position so as to allow passage of vapor from the product chamber 2 to the condenser 3. By condensing the vapor at the condenser, in particular the condenser coils 5 or condenser plates, water will be trapped during the freeze-drying process.

The freeze dryer 1 further includes a product chamber cooling circuit 10 configured to cool the product chamber 2, in particular the shelf 3 of the product chamber. The product chamber cooling circuit 10 may comprise a duct that is arranged at or runs through the shelf 3 and/or the interior of the product chamber 3 and/or a wall of the product chamber 2. The product chamber cooling circuit 10 further comprises a silicone oil as first heat transfer fluid. The first heat transfer fluid is circulated in the product chamber cooling circuit 10 by a pump 11. Thereby, heat withdrawn from the products in the product chamber 2 during a product cooling step can be transferred by the first heat transfer fluid to one or more heat exchangers 53, 54 that will be explained later.

During a freeze-drying step that typically follows the product cooling step, it is typically required to increase the temperature of the products inside the product chamber 2. For this reason, the product chamber cooling circuit 10 comprises two heaters 12, that can be activated during the freeze-drying step for heating the first heat transfer fluid of the product chamber cooling circuit and thereby also the products accommodated inside the product chamber.

Another element of the freeze-dryer 1 is a condenser cooling circuit 20 configured to cool the condenser 4. The condenser cooling circuit 20 also comprises a silicone oil as second heat transfer fluid, in particular of the same type as the silicone oil used as first heat transfer fluid in the product chamber cooling circuit 10. As visible from FIG. 1, the condenser cooling circuit 20 is separate from the product chamber cooling circuit. That means that there is no fluid connection between the condenser cooling circuit 20 and the product chamber cooling circuit 10. The condenser cooling circuit 20 comprises the condenser coils 5 or condenser plates through which the second heat transfer fluid of the condenser cooling circuit passes. The second heat transfer fluid is conveyed by a pump 21 of the condenser cooling circuit 20.

The condenser cooling circuit 20 according to the embodiment further comprises an air cycle cooling system 25 for cooling the second heat transfer fluid of the condenser cooling circuit 20. The air cycle cooling system comprises a second heat exchanger 52 for transferring heat between air in the air cycle cooling system 25 and the second heat transfer fluid, here silicone oil, of the condenser cooling circuit 20.

The condenser cooling circuit 20 is also coupled to a first additional cooling circuit 30 via a first heat exchanger 51. The first additional cooling circuit 30 includes either carbon dioxide or ammonia or liquid nitrogen as refrigerant and comprises a corresponding cooling system 31. A primary valve 33 is provided in the first additional cooling circuit for regulating refrigerant flow in the first heat exchanger 51 and thereby heat transmission between the condenser cooling circuit and the first additional cooling circuit 30.

The first additional cooling circuit 30 optionally comprises a secondary valve 34, that can be implemented as a check valve or shut-off valve. The secondary valve 34 may be implemented in addition to the primary valve 33 in order to enable operating the first heat exchanger 51 in a state where the part of the first heat exchanger 51 that is connected to the first additional cooling circuit 30 is dried out. First, the primary valve 33 can be set to a fully closed position and refrigerant can be sucked out of the first heat exchanger 51. If the secondary valve 33 is implemented as a check-vale undesired re-flow of refrigerant into the first heat exchanger 51 can be avoided. If the secondary valve 34 is implemented as shut-off valve the secondary valve 34 can be set to a fully closed position after refrigerant has been removed from the first heat exchanger 51.

The condenser cooling circuit 20 is coupled to the product chamber cooling circuit 10 via a third heat exchanger 53. A proportional three-way valve 24 is provided for regulating second heat transfer fluid flow through the third heat exchanger and second heat transfer fluid flow bypassing the third heat exchanger 53. The valve 24 is connected to a heat exchanger path 22 comprising the third heat exchanger and a bypass path 23, that is connected in parallel to the third heat exchanger 53.

A second additional cooling circuit 30′ is coupled to the same cooling system 31. The second additional cooling circuit 30′ uses the same refrigerant as the first additional cooling system, either carbon dioxide or ammonia or liquid nitrogen. The second additional cooling circuit 30′ is coupled to the product chamber cooling circuit 10 via a fourth heat exchanger 54. A valve 32 is provided in the second additional cooling circuit 30′ for regulating refrigerant flow in the fourth heat exchanger 54 and thereby heat transmission between the condenser cooling circuit and the second additional cooling circuit 30′.

According to a variation of the embodiment depicted in FIG. 1, one or more components can be provided in a redundant setup so as to compensate for defect components by using a redundant component. For example, two or more pumps 11 may be provided connected in parallel or in series for conveying the first heat transfer fluid in the product chamber cooling circuit 10. Alternatively or additionally, two or more pumps 21 may be provided connected in parallel or in series for conveying the second heat transfer fluid in the condenser cooling circuit 20. Alternatively or additionally, two or more air cycle cooling systems 25 and/or two or more second heat exchangers 52 may be provided connected in parallel or in series for cooling the second heat transfer fluid in the condenser cooling circuit 20. Alternatively or additionally, two or more cooling systems 31 may be provided connected in parallel or in series for cooling the refrigerant, in particular carbon dioxide or ammonia or liquid nitrogen, in the first additional cooling circuit 30 and/or for cooling the refrigerant, in particular carbon dioxide or ammonia or liquid nitrogen, in the second additional cooling circuit 30′.

According to another variation of the embodiment depicted in FIG. 1, one or more components can be provided in a multiple setup so as to improve cooling capacity of the freeze dryer. For example, two or more air cycle cooling systems 25 and/or two or more second heat exchangers 52 may be provided connected in parallel or in series for cooling the second heat transfer fluid in the condenser cooling circuit 20. Alternatively, or additionally, two or more cooling systems 31 may be provided connected in parallel or in series for cooling the refrigerant, in particular carbon dioxide or ammonia or liquid nitrogen, in the first additional cooling circuit 30 and/or for cooling the refrigerant, in particular carbon dioxide or ammonia or liquid nitrogen, in the second additional cooling circuit 30′.

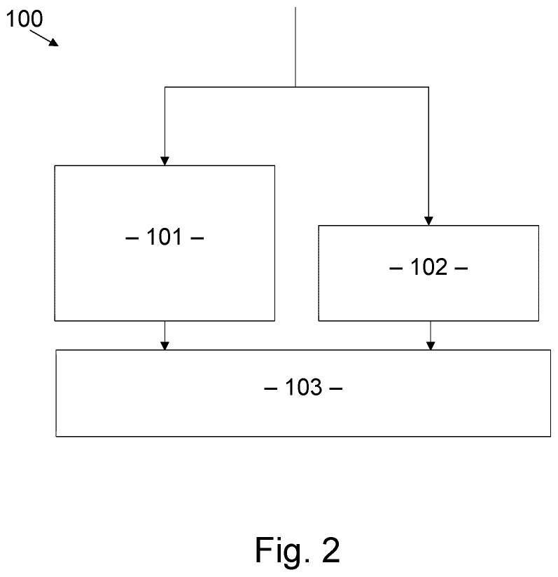

In the following, an embodiment of a method 100 for operating the freeze dryer 1 according to the invention will be described with reference to FIGS. 1 and 2. The method 100 comprises a condenser cooling step 101 that is performed partly simultaneous to a product cooling step 102. After completion of the condenser cooling step 101 and the product cooling step 102, the freeze dryer 1 performs a freeze-drying step 103. Those steps will be elucidated in detail below.

In the condenser cooling step 101, heat is transferred from the condenser cooling circuit 20 to the first additional cooling circuit 30 comprising carbon dioxide or ammonia or liquid nitrogen as refrigerant via the first heat exchanger 51. Starting from room temperature, the temperature of the condenser 4 will decrease. If the temperature of the condenser 3 or the second heat transfer fluid of the condenser cooling circuit 20 is higher than a predetermined threshold temperature the air cycle cooling system 25 will stay inactive. In this phase, the condenser cooling circuit 20 is only cooled by the first additional cooling circuit 30. The predetermined threshold temperature is in the range from −20° C. to −40° C., for example −20° C. If the temperature of the condenser 3 or the second heat transfer fluid of the condenser cooling circuit 20 falls below the predetermined threshold temperature, the air cycle cooling system 25 is activated so that additional cooling capacity is provided by the air cycle cooling system 25.

Simultaneously, cooling of the product chamber 2 is started in a product cooling step 102. During the product cooling step 102, products may be put into the product chamber 2, in particular into the shelf 3 of the product chamber 2. The valve 24 of the condenser cooling circuit 20 is adjusted so that the third heat exchanger 53 transfers heat from the product cooling circuit 10 to the condenser cooling circuit 20. Temperature of the shelf 3 and the products contained therein may be regulated by adjusting the valve 24 of the condenser cooling circuit 20.

Optionally, in the product cooling step 102, heat is transferred from the product chamber cooling circuit 10 to the second additional cooling circuit 30′ via a fourth heat exchanger 54. The operation of the fourth heat exchanger 54 can be activated by opening the valve 32 of the second additional cooling circuit 30′, preferably if the temperature of the shelf 3 or the temperature of the first heat transfer fluid of the product chamber cooling circuit 10 is within a predetermined region, e.g. between −40° C. and −51° C.

The second additional cooling circuit 30′ optionally comprises a secondary valve 35, that can be implemented as a check valve or shut-off valve. The secondary valve 35 may be implemented in addition to the primary valve 32 in order to enable operating the fourth heat exchanger 54 in a state where the part of the first heat exchanger 51 that is connected to the second additional cooling circuit 30′ is dried out. First, the primary valve 32 can be set to a fully closed position and refrigerant can be sucked out of the fourth heat exchanger 54. If the secondary valve 35 is implemented as a check-vale undesired re-flow of refrigerant into the fourth heat exchanger 54 can be avoided. If the secondary valve 35 is implemented as a shut-off valve the secondary valve 35 can be set to a fully closed position after refrigerant has been removed from the fourth heat exchanger 54.

At the beginning of the freeze-drying step 103, the temperature of the condenser 4 is at least 5° C. below the temperature in the product chamber 2. The gas passage closure is opened so that the gas passage 6 is open. The pressure inside the product chamber 2 is reduced by a vacuum pump. Then, in order to start sublimation of water contained in the products, the third heat exchanger 53 is decoupled from a flow of second heat transfer fluid in the condenser cooling circuit 20 so as to reduce heat transfer from the product chamber cooling circuit 10 to the condenser cooling circuit 20 and the first heat transfer fluid of the product chamber cooling circuit 10 is heated by the heaters 12 of the product chamber cooling circuit 10. The air cycle cooling system 25 cools the condenser cooling circuit to the lowest possible temperature depending on the vapor load. Vapor is drawn off the product chamber 2 and condenses on the condenser coils 5 or condenser plates of the condenser 4. In the freeze-drying step 103, the first heat exchanger 51 is decoupled from a flow of refrigerant in the first additional cooling circuit 30 so as to reduce heat transfer from the condenser cooling circuit 20 to the first additional cooling circuit 30.

After completion of the freeze-drying step 103 the temperature in the product chamber 2 and in the condenser 4 is increased. The products are unloaded from the product chamber. Optionally, a self-cleaning procedure or self-sterilizing procedure may succeed. During sterilization, the condenser 4 and the condenser cooling circuit 20 are heated up to a given sterilization temperature, e.g. above 121,1° C. After completion of the sterilization, the first heat exchanger may be activated again so as to cool the condenser cooling circuit 20 using the additional cooling circuit 30 in order to prepare the freeze dryer 1 for the next batch of products to be freeze-dried.

### LIST OF REFERENCE SIGNS

1 freeze dryer
2 product chamber
3 shelf
4 condenser
5 condenser coil
6 gas passage valve
10 product chamber circuit
11 pump
12 heater
20 condenser cooling circuit
21 pump
22 heat exchanger path
23 bypass path
24 three-way valve
25 air cycle cooling system
30, 30′ additional cooling circuit
31 cooling system
32 valve
33 valve
34 valve
35 valve
51 heat exchanger
52 heat exchanger
53 heat exchanger
54 heat exchanger
100 method of operating a freeze dryer
101 condenser cooling step
102 product cooling step
103 freeze-drying step

1. A freeze dryer comprising:
a product chamber configured to accommodate products to be freeze-dried,
a condenser connected to the product chamber and configured to trap water during a freeze-drying process,
a product chamber cooling circuit configured to cool the product chamber, the product chamber cooling circuit comprising a first heat transfer fluid,
a condenser cooling circuit configured to cool the condenser, the condenser cooling circuit comprising a second heat transfer fluid and being separate from the product chamber cooling circuit,
a first additional cooling circuit comprising carbon dioxide or ammonia or liquid nitrogen as refrigerant, and
a first heat exchanger configured to transfer heat between the condenser cooling circuit and the first additional cooling circuit.

2. The freeze dryer according to claim 1, wherein the first additional cooling circuit comprises a valve or a proportional valve for adjusting refrigerant flow through the first heat exchanger.

3. The freeze dryer according to claim 1, wherein the freeze dryer comprises an air cycle cooling system configured to cool the second heat transfer fluid of the condenser cooling circuit.

4. The freeze dryer according to claim 3, wherein the freeze dryer comprises by a second heat exchanger configured to couple the air cycle cooling system and the condenser cooling circuit.

5. The freeze dryer according to claim 1, wherein the freeze dryer comprises a third heat exchanger configured to transfer heat between the product chamber cooling circuit and the condenser cooling circuit.

6. The freeze dryer according to claim 5, wherein the freeze dryer comprises a valve or a three-way valve; configured to selectively couple the third heat exchanger to the condenser cooling circuit or decouple the third heat exchanger from the condenser cooling circuit.

7. The freeze dryer according to claim 5, wherein the freeze dryer comprises a fourth heat exchanger configured to transfer heat between the product chamber cooling circuit and the first additional cooling circuit or the freeze dryer comprises a second additional cooling circuit comprising carbon dioxide or ammonia or liquid nitrogen as refrigerant.

8. The freeze dryer according to claim 1, wherein the freeze dryer comprises one or more heaters configured to selectively heat the first heat transfer fluid of the product chamber cooling circuit.

9. A method of operating a freeze dryer comprising:
a product chamber configured to accommodate products to be freeze-dried,
a condenser connected to the product chamber and configured to trap water during a freeze-drying process,
a product chamber cooling circuit configured to cool the product chamber, the product chamber cooling circuit comprising a first heat transfer fluid,
a condenser cooling circuit configured to cool the condenser, the condenser cooling circuit comprising a second heat transfer fluid and being separate from the product chamber cooling circuit,
wherein the method comprises:
a condenser cooling step, where heat is transferred from the condenser cooling circuit to a first additional cooling circuit comprising carbon dioxide or ammonia or liquid nitrogen as refrigerant via a first heat exchanger.

10. The method according to claim 9, wherein in the condenser cooling step, the condenser cooling circuit is additionally cooled by an air cycle cooling system.

11. The method according to claim 9, where the method comprises:
a product cooling step, performed simultaneously with or following the condenser cooling step, where heat is transferred from the product chamber cooling circuit to the condenser cooling circuit via a third heat exchanger.

12. The method according to claim 11, wherein a temperature of the product chamber is set by adjusting a proportional valve of the condenser cooling circuits or a proportional three-way valve.

13. The method according to claim 11, wherein in the product cooling step, heat is transferred from the product chamber cooling circuit to the first additional cooling circuit via a fourth heat exchanger or to a second additional cooling circuit; comprising carbon dioxide or ammonia or liquid nitrogen as refrigerant via a fourth heat exchanger.

14. The method according to claim 11, wherein the method comprises:
a freeze-drying step, performed following the condenser cooling and product cooling steps, where the third heat exchanger is decoupled from a flow of second heat transfer fluid in the condenser cooling circuit to reduce heat transfer from the product chamber cooling circuit to the condenser cooling circuit, wherein the first heat transfer fluid of the product chamber cooling circuit is heated by one or more heaters.

15. The method according to claim 14, wherein in the freeze-drying step, the first heat exchanger is decoupled from a flow of refrigerant in the first additional cooling circuit so as to reduce heat transfer from the condenser cooling circuit to the first additional cooling circuit.
